(19) United States
(12) Patent Application Publication
(10) Pub. No.: US 2018/0297129 A1
(43) Pub. Date: Oct. 18, 2018

(54) Industrial Pipe Cutting Tool

(71) Applicant: Ty Johnnie, Orange, TX (US)

(72) Inventor: Ty Johnnie, Orange, TX (US)

(21) Appl. No.: 15/735,147

(22) PCT Filed: Jun. 9, 2016
(86) PCT No.: PCT/US16/36773

§ 371 Date: Dec. 8, 2017

Related U.S. Application Data
(60) Provisional application No. 62/173,297, filed on Jun. 9, 2015.

(51) Int. Cl. B23D 21/04

(52) U.S. Cl. CPC B23D 21/04; B23D 35/001

(57) ABSTRACT

Methods and apparatus are provided for industrial pipe cutting using a rolling wheel cutting assembly affixed to a tool slide assembly of a split ring pipe cutter.

### CROSS REFERENCE TO RELATED APPLICATIONS

This application claims priority based on U.S. Provisional Application Ser. No. 62/173,297 filed Jun. 9, 2015, which is incorporated herein by reference in its entirety.

### FIELD OF THE INVENTION

This invention relates generally to apparatus and methods for cold cutting of large diameter pipes. The present invention relates more particularly to improved apparatus and methods for the use of split ring pipe cutters.

### BACKGROUND OF THE INVENTION

Without limiting the scope of the invention, its background is described in connection with the cold cutting of industrial metal pipes ranging in size from approximately an inch in diameter to over 100 inches in diameter. Industrial metal pipes can be “hot” cut using cutting torches and grinders but for many on-site applications, particularly in petrochemical and other chemical plants, on-site machining of pipe for repair and further construction must utilize cold cutting. Cold cutting of large diameter pipes is typically accomplished with a split ring or clamshell lathe that is mounted around the pipe. The split rings consist of two integrated rings, one stationary ring that clamps to the pipe to be cut and one motor driven rotating ring that circles the pipe as cutting progresses. Split ring lathes include a cutting head assembly that is fixed to the rotating ring and applies a cutting bit against the pipe surface. An example of such an apparatus is disclosed in U.S. Pat. No. 4,762,038. As the rotating ring rotates, the cutting blade drags across the surface of the pipe generating shavings of cut metal and ultimately cutting completely through the pipe wall. The cutting blades used in split ring pipe cutters have been essentially the same for almost fifty years. While highly efficient and certainly cooler than a cutting torch, the cutting blades of existing split ring tools generate considerable heat through friction and are not available for use in explosive environments.

From the foregoing it is apparent the there is a need in the art for a cutting tool for split ring pipe cutters that will not generate excessive heat. The invention described herein provides a novel method and apparatus for cool cutting of industrial pipe.

### BRIEF SUMMARY

In one embodiment a pipe cutting apparatus is provided that includes a split ring pipe lathe having a segmented base ring that is held against a pipe to be cut and a segmented rotatable gear ring connected to the base ring, wherein the rotatable gear ring adapted to be driven to rotate around the pipe by a motor affixed to the base ring. At least one tool slide assembly is affixed to the gear ring and a rolling wheel pipe cutting tool mounted in the tool slide assembly, the rolling wheel pipe cutting tool including body comprising a truck and a pair of arms and a rolling wheel affixed between the arms. The motor may be a hydraulic motor, a pneumatic motor or an electric motor. In certain embodiments, the split ring pipe lathe pipe cutting apparatus includes a trip assembly mounted on the base ring and the tool slide assembly includes an advancing wheel that is adapted to be turned and advance the tool slide assembly and the mounted rolling wheel pipe cutting tool when the gear ring rotates and the advancing wheel passes the trip assembly. In certain embodiments a plurality of tool slide assemblies are attached to the gear ring, each holding a rolling wheel pipe cutting tool.

Also provided is a rolling cutting wheel body dimensioned and adapted to be mounted in a split ring tool slide assembly, the rolling cutting wheel body comprising a trunk that is adapted to be mounted in a tool slide of the split ring tool slide assembly and a pair of arms extending from the trunk, wherein each of the pair of arms include an aligned through hole dimensioned to hold a center pinion or bolt on which a cutting wheel can be rotatably mounted. In certain embodiments the pair of arms extending from the trunk are dimensioned to hold a cutting wheel that is greater than 2 inches in diameter. In certain embodiments the cutting wheel is dimensioned to cut a 37° bevel.

Also provided is a rolling wheel pipe cutting tool including a rolling wheel body dimensioned and adapted to be mounted in a split ring tool slide assembly, the rolling wheel body including a trunk that is adapted to be mounted in a tool slide of the split ring tool slide assembly and a pair of arms extending from the trunk, wherein each of the pair of arms include an aligned through hole dimensioned to hold a center pinion or bolt, and cutting wheel rotatably mounted on the center pinion or bolt.

In certain embodiments a method of cutting pipe is provided that includes affixing a portable motorized split ring lathe around a pipe to be cut, mounting a rolling wheel pipe cutting tool in a split ring tool slide assembly of the portable motorized split ring lathe, engaging a motor of the portable motorized split ring lathe, and allowing the rolling wheel pipe cutting tool to circle the pipe until the pipe is cut. The method provides for cold cutting of metal pipe and is safely practiced in potentially explosive environments including petrochemical plant.

### BRIEF DESCRIPTION OF THE DRAWINGS

For a more complete understanding of the present invention, including features and advantages, reference is now made to the detailed description of the invention along with the accompanying figures:

FIG. 1A represents a top down view of a rolling wheel cutting tool attachment according to one embodiment of the present invention.

FIG. 1B represents a side down view of the rolling wheel cutting tool attachment of FIG. 1A.

FIG. 2A illustrates a top down view of a rolling wheel cutting tool attachment according to one embodiment of the present invention.

FIG. 2B illustrates a side down view of the rolling wheel cutting tool attachment of FIG. 2A.

FIG. 3 shows a rolling wheel cutting tool attachment according to one embodiment of the present invention mounted on a split ring pipe cutter.

FIG. 4 depicts a rolling wheel cutting tool attachment according to one embodiment of the present invention mounted on a split ring pipe cutter.

FIG. 5 depicts a tool slide assembly holding a prior art cutting blade.

FIG. 6 depicts a tool slide assembly holding a rolling wheel cutting tool attachment according to one embodiment of the present invention.

FIG. 7 illustrates a top down view of a rolling wheel cutting tool attachment according to one embodiment of the present invention and the resulting angle of cut pipe.

FIG. 8 illustrates a top down view of another embodiment of a rolling wheel cutting tool attachment having a broader bevel and the resulting angle of cut pipe.

FIG. 9A shows a bottom view of a rolling wheel tool holder according to one embodiment. FIG. 9B shows a side view of the embodiment of FIG. 9A. FIG. 9C shows a top view of the embodiment of FIG. 9A.

### DETAILED DESCRIPTION OF THE INVENTION

While the making and using of various embodiments of the present invention are discussed in detail below, it should be appreciated that the present invention provides many applicable inventive concepts which can be employed in a wide variety of specific contexts. The specific embodiment discussed herein are merely illustrative of specific ways to make and use the invention and do not delimit the scope of the invention.

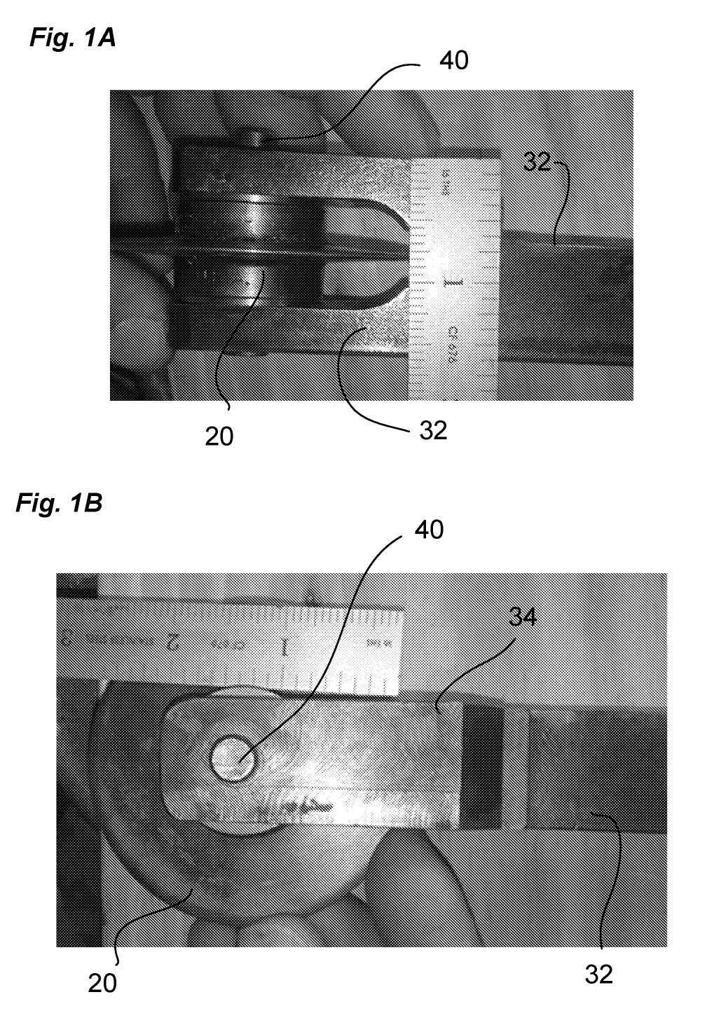

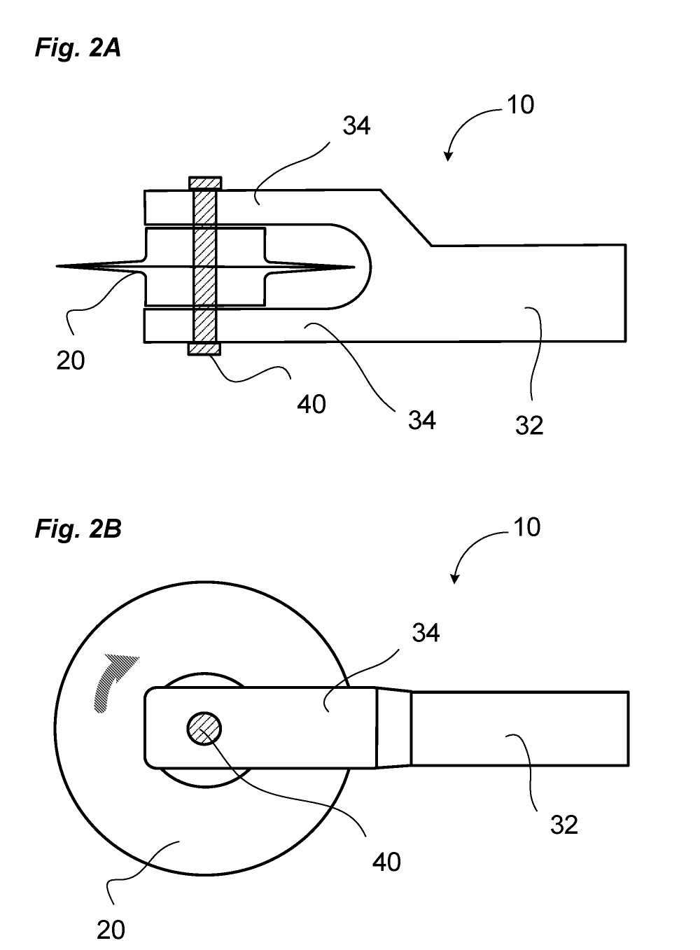

In one embodiment depicted in FIGS. 2A and 2B a split ring rolling wheel pipe cutting tool 10 is provided that includes a freely rolling cutting wheel 20 mounted on body 30 via center pinion or bolt 40. FIGS. 1A and 1B depict a working embodiment of a split ring rolling wheel pipe cutting tool.

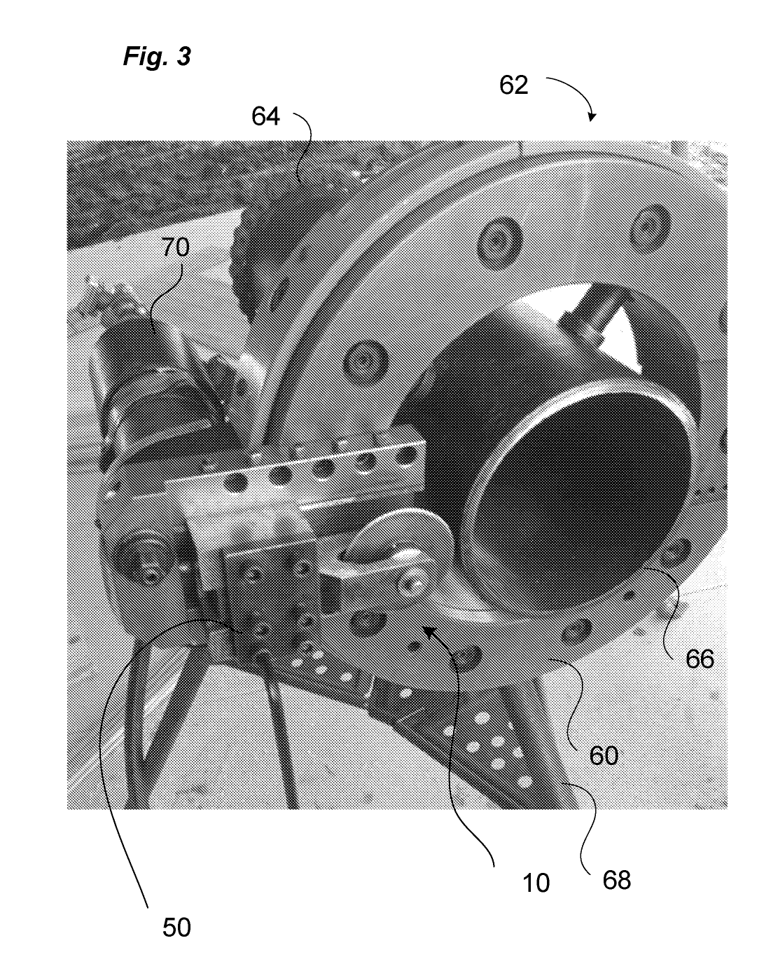

FIG. 3 depicts a working embodiment of a split ring rolling wheel pipe cutting tool 10 mounted in a sliding tool holder 50 which is in affixed to the rotating ring 60 of a split frame pipe cutting assembly 62 as utilized around pipe 66 to be cut. As depicted the pipe 66 is secured to pipe stand 68 with chain 64. In the depicted embodiment, the split ring pipe cutter assembly is a portable pipe lathe, split frame, manufactured by Aggressive Equipment, Rock Hill, South Carolina. However, the rolling wheel pipe cutting tool provided herein is adaptable to a variety of pipe cutters including the depicted split ring cutter. Consistent with the operation of typical split ring pipe cutters, the drive motor 70 may be pneumatic, hydraulic or electric. The tool slide is advanced incrementally toward the pipe by the action of a star wheel feed assembly that is advanced by hitting a trip assembly with each rotation of the rotating ring. Because the cutting tool freeing rolls around the pipe, it generates relatively little friction and produces little heat, no sparks and no metal shavings. Thus, this pipe cutter can be used in flammable and combustible environments inside petrochemical plants.

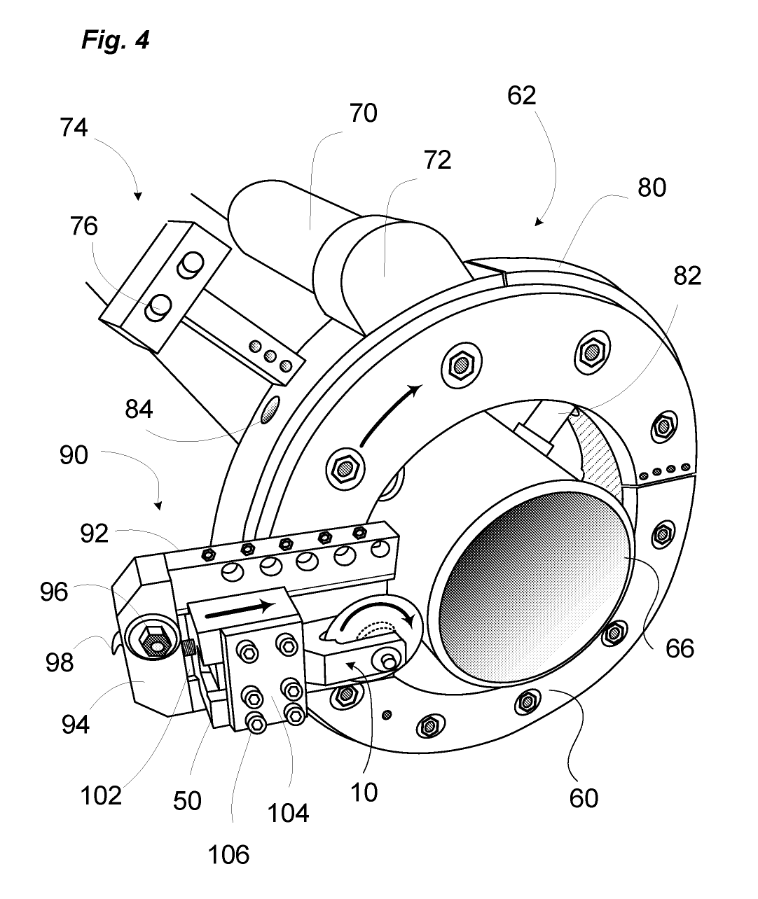

FIG. 4 depicts an embodiment of a split ring rolling wheel pipe cutting tool 10 mounted in a sliding tool holder 50 which is in affixed to the rotating ring 60 of a split frame pipe cutting assembly 62 affixed around pipe 66 having just been cut. Portable split frame pipe lathe such as that depicted includes a two part or “split” frame. The frame in turn includes two parts, a stationary base ring 80 and a rotating gear ring 60. The gear ring will typically include (not shown) bearings, a drive gear and a tool slide placement slot. Base ring 80 is affixed to the pipe via a plurality centering legs 82, which are tightened via leg bolts that are reached through access holes 84. Motor 70 is engaged to gear box 72 mounted to the stationary base ring 80. Trip assembly 74 is also mounted to the stationary base ring 80. The trip assembly will include trip arms or posts 76.

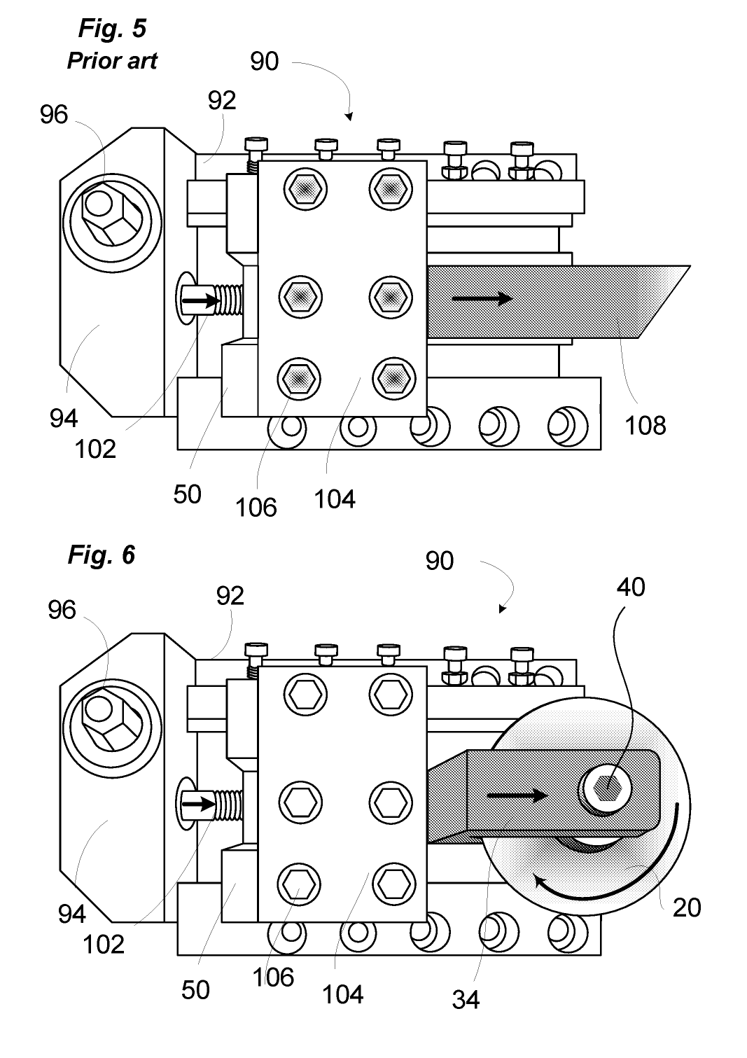

Tool slide assembly 90 is bolted to the gear ring and includes slide base 92 and gear box 94. Sliding tool holder 50 is slidably mounted on slide base 92. The cutting tool to be utilized is secured between the sliding tool holder and tool holder cover 104, which is tightened against the cutting tool by screws 106. An advancing wheel 98 (such as the star wheel partially showing) is affixed through gear box 94 via an advancing (star) wheel cap nut 96. The advancing wheel is operably attached to lead screw 102 via gears within gear box 94. In operation, as the tool slide assembly rotates on the gear ring, the advancing wheel, such as a star wheel, hits the trip arm or post in each rotation and this advances the lead screw which pushes against the tool slide and moves the tool slide slowly and progressively toward the pipe. As depicted in FIG. 5, prior to the present invention, sliding tool holder 50 would hold a chisel shaped cutting tool such as cutting tool 108. Each rotation of the gear ring and affixed tool slide assembly will act to push the chisel shaped cutting tool against the pipe to be cut. Problematically, the chisel shaped cutting tool acts by removing metal from the pipe. In addition to considerable friction resulting in high heat and sparks, metal shavings are produced by the action of the prior art chisel cutters.

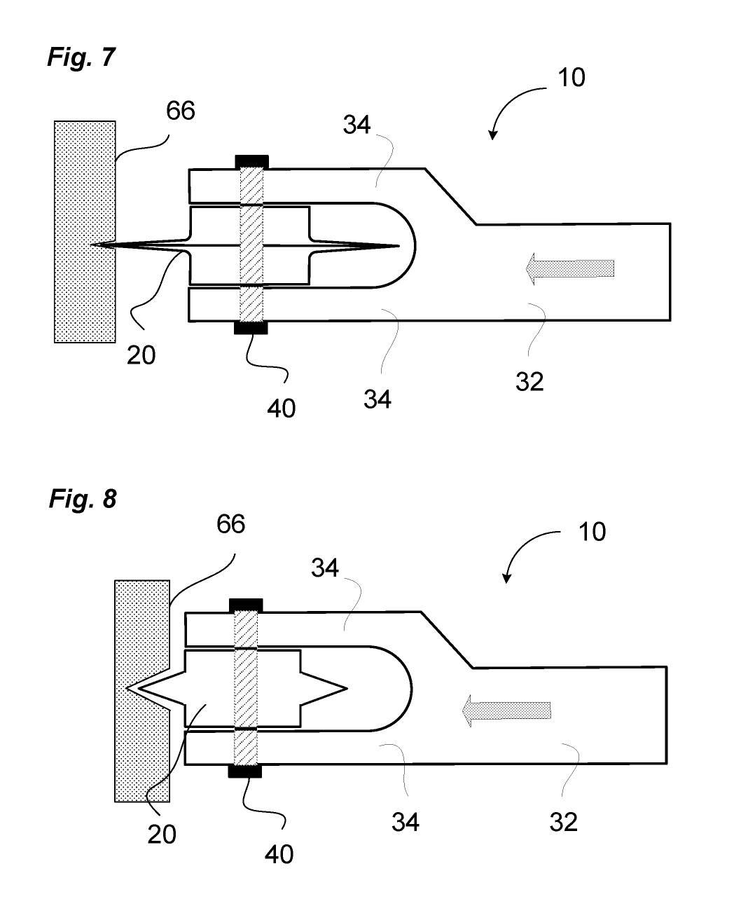

As depicted, in FIGS. 3, 4 and 6, the present inventor designed a tool holder that would allow a rolling wheel cutter to be utilized in an automated split ring pipe lathe for the first time in the almost 50 year history of the split ring pipe cutter. Thus, as depicted in FIG. 6, a tool holder 30 is provided that securely holds rolling wheel 20 that turns on center pin 40. The provided tool holder 30 can be cast or machined to fit into virtually any tool slide assembly. As the tool slide is advanced incrementally toward the pipe by the action of an advancing wheel feed assembly that is advanced by the hitting of the trip assembly with each rotation of the rotating ring, the cutting wheel is pushed incrementally against the pipe. However, unlike all prior split ring lathe tools, the cutting wheel is able to roll against the pipe. As depicted in FIGS. 7 and 8, as the rolling wheel 20 advances against the pipe and rolls along it, it effectively pushes or displaces the metal it rolls against thus forming a cut surface capitulating the angle of the cutting wheel. In the embodiment depicted in FIG. 7, the cutting wheel forms a 37° standard bevel. By the rolling motion of the wheel, there is little or no friction, very little heat produced and no metal shavings. Test have shown the temperature of the pipe as it is being “cut” by the rolling wheel is barely above ambient temperature. Thus, this pipe cutter can be used in flammable and combustible environments inside petrochemical plants. Furthermore, the process is faster than cutting with the prior art chisel cutters employed in split ring lathes.

In certain embodiments, a single split ring rolling wheel pipe cutting tool is utilized on the split ring lathe. In other embodiments two or more tool slide assemblies are mounted on the gear ring, each holding a split ring rolling wheel pipe cutting tool thus providing a plurality of rolling wheels engaged against the pipe.

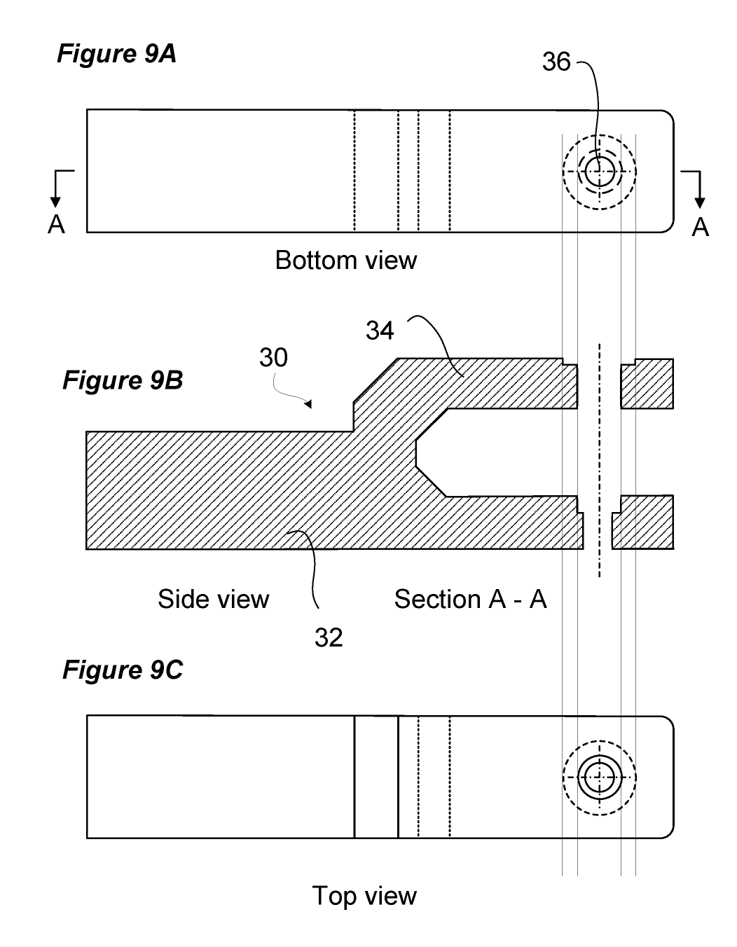

FIGS. 9A-C depict bottom, side and top view respectively of one embodiment of a split ring rolling wheel pipe cutting tool body 30. As depicted in FIG. 9b, the body 30 includes a trunk 32 that will be held by a sliding tool holder of a split ring lathe and a pair of arms 34. Each arm includes a through hole dimensioned to hold a center pinion or bolt on which the cutting wheel (not shown will be mounted).

All publications, patents and patent applications cited herein are hereby incorporated by reference as if set forth in their entirety herein. While this invention has been described with reference to illustrative embodiments, this description is not intended to be construed in a limiting sense. Various modifications and combinations of illustrative embodiments, as well as other embodiments of the invention, will be apparent to persons skilled in the art upon reference to the description. It is therefore intended that the appended claims encompass such modifications and enhancements.

1. A pipe cutting apparatus comprising:
a split ring pipe lathe having a segmented base ring that is held against a pipe to be cut and a segmented rotatable gear ring connected to the base ring, wherein the rotatable gear ring is adapted to be driven to rotate around the pipe by a motor affixed to the base ring;
at least one tool slide assembly affixed to the gear ring; and
a rolling wheel pipe cutting tool mounted in the tool slide assembly, the rolling wheel pipe cutting tool including a body comprising a trunk and a pair of arms and a rolling wheel affixed between the arms.

2. The pipe cutting apparatus of claim 1, wherein the motor is a hydraulic motor.

3. The pipe cutting apparatus of claim 1, wherein the motor is a pneumatic motor.

4. The pipe cutting apparatus of claim 1, wherein the motor is an electric motor.

5. The pipe cutting apparatus of claim 1, wherein the wheel is dimensioned to cut a 37° bevel.

6. The pipe cutting apparatus of claim 1, wherein the split ring pipe lathe comprises a trip assembly mounted on the base ring and the tool slide assembly includes an advancing wheel that is adapted to be turned and advance the tool slide assembly and the mounted rolling wheel pipe cutting tool when the gear ring rotates and the advancing wheel passes the trip assembly.

7. The pipe cutting apparatus of claim 1, comprising a plurality of tool slide assemblies each holding a rolling wheel pipe cutting tool.

8. A rolling cutting wheel body dimensioned and adapted to be mounted in a split ring tool slide assembly, the rolling cutting wheel body comprising a trunk that is adapted to be mounted in a tool slide of the split ring tool slide assembly and a pair of arms extending from the trunk, wherein each of the pair of arms include an aligned through hole dimensioned to hold a center pinion or bolt on which a cutting wheel can be rotatably mounted.

9. The rolling wheel body of claim 9, wherein the pair of arms extending from the trunk are dimensioned to hold a cutting wheel that is greater than 2 inches in diameter.

10. A rolling wheel pipe cutting tool comprising:
a rolling wheel body dimensioned and adapted to be mounted in a split ring tool slide assembly, the rolling wheel body comprising a trunk that is adapted to be mounted in a tool slide of the split ring tool slide assembly and a pair of arms extending from the trunk, wherein each of the pair of arms include an aligned through hole dimensioned to hold a center pinion or bolt; and
a cutting wheel rotatably mounted on the center pinion or bolt.

11. The rolling wheel body of claim 10, wherein the cutting wheel is greater than 2 inches in diameter.

12. A method of cutting pipe comprising:
affixing a portable motorized split ring lathe around a pipe to be cut;
mounting a rolling wheel pipe cutting tool to a split ring tool slide assembly affixed to a rotating gear ring of the portable motorized split ring lathe;
engaging a motor of the portable motorized split ring lathe to power the rotating gear ring; and
allowing the rolling wheel pipe cutting tool to circle the pipe until the pipe is cut.

13. The method of claim 12, wherein the pipe is located in a potentially explosive environment and is cut in the potentially explosive environment.

14. The method of claim 13, wherein the potentially explosive environment is a petrochemical plant.

15. The method of claim 12, wherein the portable motorized split ring pipe lathe comprises a trip assembly mounted on a base ring and the split ring tool slide assembly includes an advancing wheel that turns and advances the tool slide assembly and the mounted rolling wheel pipe cutting tool when the gear ring rotates and the advancing wheel passes the trip assembly.

16. The method of claim 12, comprising mounting a plurality of tool slide assemblies to the rotating gear ring of the portable motorized split ring lathe, each tool slide assembly holding a rolling wheel pipe cutting tool.
